(19) United States
(12) Patent Application Publication
(10) Pub. No.: US 2012/0322597 A1
(43) Pub. Date: Dec. 20, 2012

(54) BELT OR CHAIN DRIVE

(76) Inventor: Hans HUNDEGGER, Hawangen (DE)

(21) Appl. No.: 13/469,954

(22) Filed: May 11, 2012

(30) Foreign Application Priority Data
Jun. 14, 2011 (DE) 102011104177.3

(51) Int. Cl. F16H 7/06

(52) U.S. Cl. 474/148

(57) ABSTRACT

The invention concerns a belt or chain drive with at least one belt-shaped or chain-shaped drive element (1) conducted via drive or deflection disks (2, 3). For the accurate detection of the movement or for the exact transport of a component, movable entraining elements (7) are located in the belt-shaped or chain-shaped drive element (1) transverse to the movement direction of the drive element (1), between a withdrawal position and an extended entraining position, and an actuation device (11), by means of which the entraining elements (7) can be moved into the entraining position in a non-curved area of the drive element (1), is assigned to the drive element (1).

### CROSS REFERENCE TO RELATED APPLICATION

This application claims priority under 35 U.S.C. §119 to German Patent Application No. 10 2011 104 177.3 filed 14 Jun. 2011, the entire contents of which are incorporated herein by reference.

### FIELD OF THE INVENTION

The invention concerns a belt or chain drive with at least one belt-shaped or chain-shaped drive element, which is conducted via drive or deflection disks.

### BACKGROUND OF THE INVENTION

Belt or chain drives of the type mentioned in the beginning are usually used to transfer power between shafts at a greater distance from one another. Such belt or chain drives, however, can also be used as transport or measurement devices on assembly systems or other processing machines for the processing of wooden beams; boards, plates, or other extrusion materials. Thus, for example, wooden beams can also be transported via belt or chain drives or the movement of a wooden beam transported during processing can be detected. To detect the movement of a wooden beam, the belt or chain drive, for example, can be arranged in such a manner that the lower or upper end of the belt-shaped or chain-shaped drive element comes to a stop on one of the longitudinal sides of the wooden beam transported in the longitudinal direction, so that the drive element is taken along with a displacement of the beam. By detection of the rotary movement of one of the two drive disks of the belt or chain drive, the movement of the wooden beam can thus be detected.

However, with such measurement devices, there is the problem that slack can appear between the wooden beam and the belt or chain drive, which leads to measurement inaccuracies. Slack could be prevented in that fixed mandrels, pins, or other entraining elements protruding outwards, which mesh into the moved component in a form-locking manner and lie firmly in it, are provided on the belt or the chain, so as to prevent a relative movement between the belt or the chain and the moved component. With the arrangement of such fixed entrainers on a belt or a chain conducted via drive or deflection disks, there is, however, the problem that the distance between the entraining elements protruding on the outside of the belt or the chain changes in the area of the drive or deflections disks because of the curvature of the belt or the chain at that point. The ends or tips of the entraining elements, which protrude outwards from the outside of the belt or the chain, exhibit a higher speed during the deflection of the belt or the chain via the drive or deflection disks on the outside than in the areas in which the belt or the chain is not curved. Only if the drive belt or the chain has no curvature do the entraining elements protruding on the outside of the belt carry out a movement corresponding to the effective diameter. However, since the entraining elements, as a rule, already mesh in the area of the drive disks before the complete extension of the drive element with the moved component, inaccuracies may result during the measurement.

### SUMMARY OF THE INVENTION

A goal of one aspect of the invention is to create a belt or chain drive of the type mentioned in the beginning, which is suitable for the precise detection of the movement or the exact transport of a component.

This goal is attained by a belt or chain drive as disclosed herein. Appropriate refinements and advantageous embodiments of the invention are also disclosed.

In the belt or chain drive in accordance with the invention, movable entraining elements are located in the belt-shaped or chain-shaped drive element, transverse to the movement direction of the drive element between a withdrawal position and an extended entraining position. An actuation device, by means of which the entraining elements can be moved in a noncurved area of the drive element into the entraining position, is also assigned to the drive element. The solution, in accordance with the invention, guarantees that the entraining elements provided on the belt or the chain arrive at the extended entraining position only when the drive element is situated in a completely extended, no longer curved position. Only in this position can a constant defined distance be guaranteed between the entraining elements protruding from the outside of the drive element and thus an erroneous measurement or an inexact transport be avoided when using the belt or chain drive as a measuring or transport device.

In a particularly expedient embodiment of the invention, the actuation device is located between the drive or deflection disks in such a way that the entraining elements are pressed into their entraining position by the movement of the drive element only, for example, at an end of the drive element adjacent to a moved beam or another component, whereas the entraining elements in the other end and in the areas of the drive element curved around the drive disks by the deflection of the drive element remain in their withdrawal position.

For use on wooden components, the entraining elements can be constructed, for example, as entraining rods with a head on the inside of the drive element and an entraining tip that protrudes outwards in the entraining position with respect to the outside of the drive element. The entraining tip can be pressed into the wooden component in the entraining position and provide for a slip-free connection between the drive element and the wooden beam. The entraining elements, however, can also be designed as movable support pads or in some other suitable manner.

The entraining elements are pressed into their withdrawal position in a simple manner by suitable resetting elements. The resetting elements can be designed, for example, as rings made of rubber or another elastic flexible material. However, the resetting elements can also be springs or the like.

The actuation device for the movement of the entraining elements between the withdrawal position and the extended entraining position can consist of two guide tracks at a distance from one another in a model that is simple in its construction; a disk-shaped head of the entraining elements is conducted between the two guide tracks.

A sensor or another suitable device for the detection of a rotary movement can be assigned to at least one of the drive or deflection disks. The movement of the drive element can also be detected directly or via another tension and deflection roller.

### BRIEF DESCRIPTION OF THE DRAWINGS

Other special features and advantages of the invention can be deduced from the following description of a preferred exemplified embodiment with the aid of the drawing. The figures show the following:

FIG. 1, a belt drive in accordance with the invention in a side view.

FIG. 2, a partial view of the belt drive of FIG. 1;

FIG. 3, a sectional view along line B-B of FIG. 2; and

FIG. 4, a sectional view along line A-A of FIG. 2.

### DETAILED DESCRIPTION OF THE INVENTION

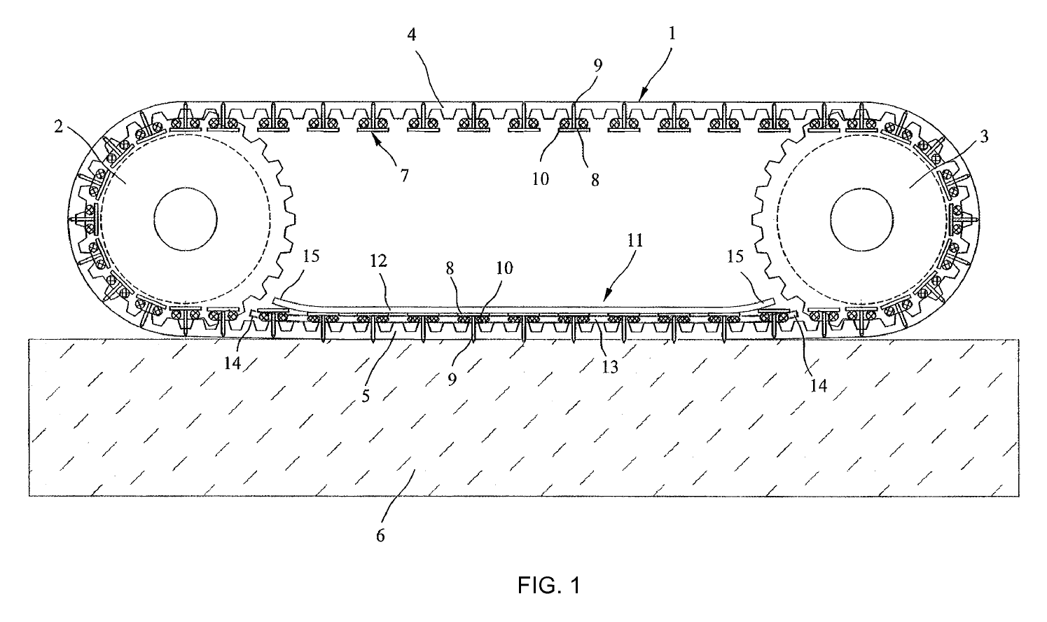

The belt drive shown schematically in FIG. 1 contains a belt-shaped drive element 1 designed here as a toothed belt that is conducted via two drive or deflection disks 2 and 3 constructed here as toothed disks. The belt drive is placed in such a manner that the upper end 4 of the belt-shaped drive element 1 is free, whereas the lower end 5 of the belt-shaped drive element 1 faces with its outside a longitudinal side of a wooden beam transported in the longitudinal direction or another moved component 6.

In the depicted exemplified embodiment, the belt drive is part of a measuring device to detect the movement of the component 6 that is moved in the longitudinal direction, wherein one of the two drive or deflection disks 2 or 3 is connected to a nondepicted sensor or another suitable device for the detection of the rotary movement of the drive or deflection disks 2 and 3. The drive element 1 is adjacent to the component 6 that is moved in the longitudinal direction, so that the drive element 1 is entrained by a displacement of the component 6 transported, for example, on a support. By the detection of the rotary movement of one of the two drive or deflection disks 2 or 3, the movement of the component 4 can thus be detected.

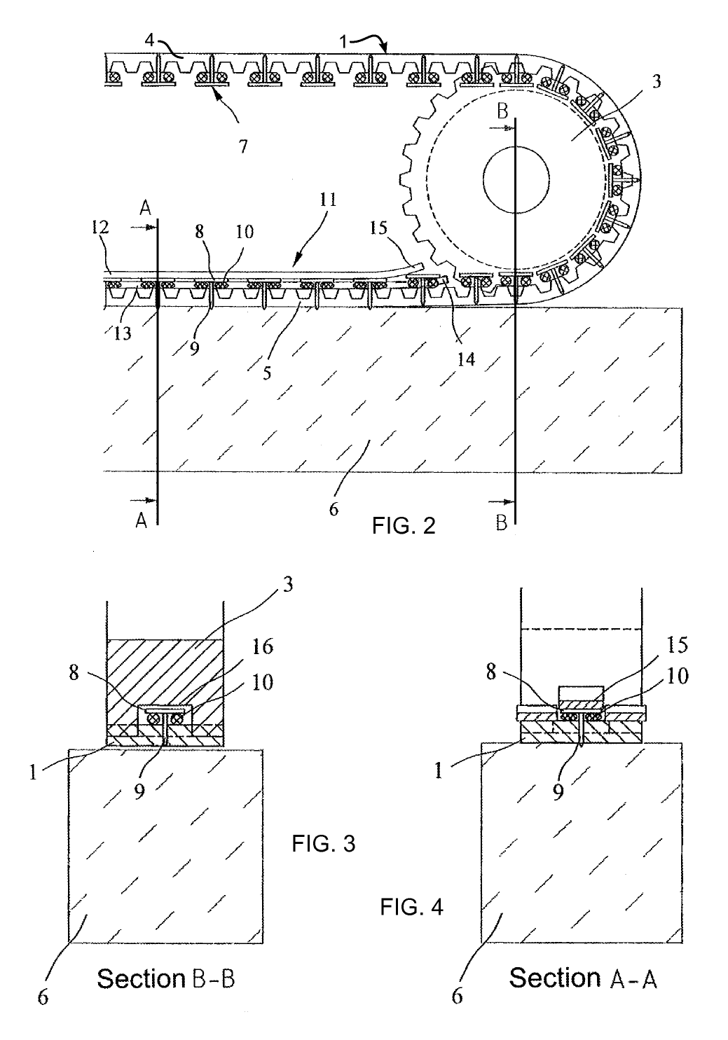

As can be seen from FIGS. 1 to 4, several entraining elements 7, movable transverse to the movement direction of the drive element 1, are located in the belt-shaped drive element 1. The entraining elements 7 can be moved within the drive element 1 between a withdrawal position shown in FIG. 3 and an entraining position shown in FIG. 4. In the exemplified embodiment shown, the entraining elements 7 conducted in a displaceable manner in the drive element 1 are constructed as entraining rods with a disk-shaped head 8 on the inside of the belt-shaped drive element 1 and a rod 9 with a tip that protrudes outwards in the entraining position with respect to the outside of the drive element 1. The rod-shaped entraining elements 7 are pressed into their withdrawal position by resetting elements 10. In the embodiment shown in the drawing, the resetting elements 10 are made of rubber or another elastic flexible material. The resetting elements 10 are laid between the head 8 of the entraining elements 7 and the inside of the belt-shaped drive element 1.

To move the entraining elements 7 into the entraining position, an actuation device 11 is assigned to the drive element 1; by means of the actuation device, the entraining elements 5 can be moved into the entraining position. The actuation device 11 is designed and located in such a way that the entraining elements 7 are pressed into their entraining position only in the noncurved area of the lower end 5 of the drive element 1, adjacent to the component 4, whereas the entraining elements 7 remain in their withdrawal position in the free end 4, which is not adjacent to the component 6, and in the curved areas of the drive element 1 caused by the deflection of the drive element 1 around the drive or deflection disks 2 and 3.

The actuation device 11 located in the area of the lower end 5 between the two drive or deflection disks 2 and 3 consists of an upper guide track 12 and a lower guide track 13 parallel to it, between which the disk-shaped head 8 of the entraining element 7 is guided for the displacement between the withdrawal position shown in FIG. 3 and the entraining position shown in FIG. 4. The two guide tracks 12 and 13 have deflection areas 14 and 15, which at both ends are bent upwards and which are located in the vicinity of the drive disks 2 and 3.

As can be seen in FIGS. 3, a rectangular groove 16 to accept the head 8 and the resetting elements 10 of the entraining elements 7 is provided on the outside in the two drive disks 2 and 3 constructed as toothed disks. Via the rod 9 provided with the tip, the entraining elements 7 are guided into corresponding passages of the belt-shaped drive element 1 in a displaceable manner.

If, for example, the component 6 shown in FIG. 1 is moved left in the longitudinal direction, the belt-shaped transport element 1 is entrained and drives the two drive or deflection disks 2 and 3 in a clockwise direction. By the detection of the rotary movement of a drive or deflection disk, it is then possible to determine the movement of the component. The entraining elements 7 in the area of the no longer curved transport belt 1, which lies flat on the component 6, are pressed downwards against the force of the increasingly compressed resetting elements 10 into their entraining position by the deflection areas 14 and 15 of the guide tracks 12 and 13 located next to the right drive disk 3, wherein the tips of the rods 9, which protrude with respect to the outside of the belt-shaped drive element 1, are pressed into the component 6 and provide a slip-free connection between the drive element 1 and the component 6. By the deflection areas 14 and 15 of the guide tracks 12 and 13 located next to the left drive disk, the entraining elements 7 can be moved into the withdrawal position by the resetting elements 10, which are then once again relaxed.

Instead of the previously described belt-shaped drive element, it is also possible to use a chain-shaped drive element. The belt or chain drive is not limited either to the explained use as a measuring device for the detection of the movement of a component made of wood or the like transported for the process. The belt or chain drive in accordance with the invention can, for example, also be used as a transport device, in that the belt or chain drive is driven by a drive motor and the belt or chain drive is used for the transport of the workpiece.

All references cited herein are expressly incorporated by reference in their entirety. In addition, unless mention was made above to the contrary, it should be noted that all of the accompanying drawings are not to scale. There are many different features to the present invention and it is contemplated that these features may be used together or separately. Thus, the invention should not be limited to any particular combination of features or to a particular application of the invention. Further, it should be understood that variations and modifications within the spirit and scope of the invention might occur to those skilled in the art to which the invention pertains. Accordingly, all expedient modifications readily attainable by one versed in the art from the disclosure set forth herein that are within the scope and spirit of the present invention are to be included as further embodiments of the present invention.

1. Belt or chain drive with at least one belt-shaped or chain-shaped drive element (1) conducted via drive or deflection disks (2,3), wherein movable entraining elements (7) are located in the belt-shaped or chain-shaped drive element (1) transverse to the movement direction of the drive element (1), between a withdrawal position and an extended entraining position, and in that an actuation device (11), by means of which the entraining elements (7) can be moved into the entraining position in a noncurved area of the drive element (1), is assigned to the drive element (1).

2. Belt or chain drive according to claim 1, wherein the actuation device (11) is located between the drive or deflection disks (2,3) in such a way that the entraining elements (7) are pressed by movement of the drive element (1) into their entraining position only in one end (5) of the drive element (1), whereas the entraining elements (7) remain in the other end (6) and in the areas of the drive element (1) that are curved by the deflection of the drive element (1) around the drive or deflection disks (2,3).

3. Belt or chain drive according to claim 1, wherein the entraining elements (7) are constructed as entraining rods with a head (8) on the inside of the drive element (1) and a rod (9) that protrudes outwards in the entraining position with respect to the outside of the drive element (1).

4. Belt or chain drive according to claim 1, wherein the entraining elements (7) are pressed into their withdrawal position by resetting elements (10).

5. Belt or chain drive according to claim 4, wherein the resetting elements (10) are designed as rings made of an elastic flexible material.

6. Belt or chain drive according to claim 3, wherein the actuation device (11) consists of two guide tracks (12,13) at a distance from one another, between which the head (8) of the entraining elements (7) is conducted.

7. Belt or chain drive according to claim 6, wherein the guide tracks (12,13) have on their two ends deflection areas (14,15).

8. Belt or chain drive according to claim 3, wherein the drive or deflection disks (2,3) have a groove (16) to accept the head (8) and the resetting element (10) of the entraining elements (7).

9. Belt or chain drive according to claim 1, wherein at least one of the drive or deflection disks (2,3) or a device to detect the rotary movement of the drive or deflection disks (2,3) or to detect the movement of the drive element (1) is assigned to the drive element (1).
